(19) United States
(12) Patent Application Publication
(10) Pub. No.: US 2004/0227988 A1
(43) Pub. Date: Nov. 18, 2004

(54) Catadioptric projection lens and method for compensating the intrinsic birefringence in such a lens

(76) Inventors: Michael Albert, Seymour, CT (US); Vladimir Kamenov, Oberkochen (DE)

Correspondence Address: FACTOR & LAKE, LTD, 1327 W. WASHINGTON BLVD., SUITE 5G/H, CHICAGO, IL, 60607, US

(21) Appl. No.: 10/657,756

(22) Filed: Sep. 8, 2003

Related U.S. Application Data
(60) Provisional application No. 60/409,255, filed on Sep. 9, 2002.

(51) Int. Cl. G02B 17/00; G02B 21/00; G02B 23/00

(52) U.S. Cl. 359/364; 359/729

(57) ABSTRACT

A catadioptric projection lens (1) which is designed in particular for use in microlithographic projection-exposure apparatus includes a plurality of refractive optical elements having intrinsic birefringence both in a catadioptric part (5) and in a dioptric part (18) adjacent to the image plane (3). Because these refractive optical elements in the catadioptric part (5) and in the dioptric part (18) are decoupled from one another with respect to polarisation by a polarisation-sensitive reflective layer (10), the catadioptric part (5) and the dioptric part (18) are compensated separately from one another with respect to intrinsic birefringence.

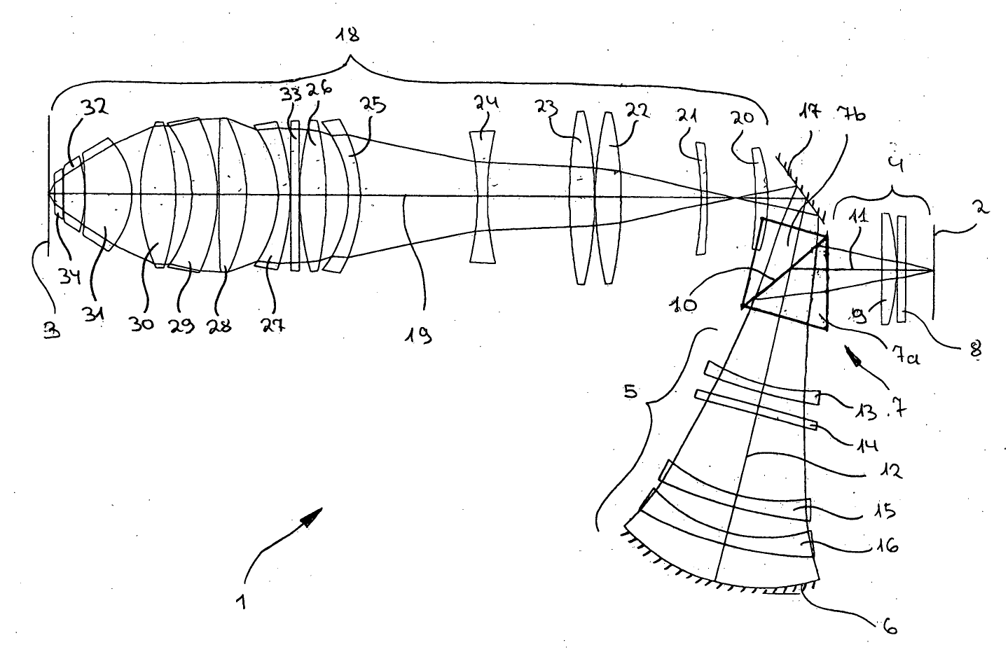

The invention relates to a catadioptric projection lens, in particular for use in microlithographic projection-exposure apparatus, according to the preamble of claim 1, together with a method for compensating the intrinsic birefringence in a projection lens according to the preamble of claim 11.

Projection lenses and microlithographic projection-exposure apparatuses of the above-mentioned type are described, for example, in WO 01/50 171 A1. Because of the operating wavelength of 193 nm or 157 nm employed, calcium fluoride is used as the material of the refractive optical components, i.e. in particular of the lenses. It is known from the article “Intrinsic birefringence in calcium fluoride and barium fluoride” by J. Burnett et al. (Physical Review B, vol. 64 (2001), pp. 241102-1 to 241102-4) that lenses made of fluoride crystals have intrinsic birefringence. This property is strongly dependent on the orientation of the material of the fluoride crystal lens and on the beam direction.

When a crystal direction (100) is referred to hereinafter, the principal crystal direction <100>, and the crystal directions equivalent thereto resulting from the symmetry properties of cubic crystals, are meant. Correspondingly, the term (110) direction refers to the crystal direction <110> and the equivalent crystal directions. Finally, the term (111) characterises both the crystal direction <111> and the equivalent crystal directions in the cubic crystal.

The intrinsic birefringence in calcium fluoride has its maximum effect on a beam having a refractive optical component which transits along a (110) crystal direction. With a beam propagation in the (100) crystal direction and in the (111) crystal direction, however, calcium fluoride does not have intrinsic birefringence, as is also predicted by theory.

In the article “The Trouble with Calcium Fluoride” by J. Burnett et al. (SPIE's OEmagazine, March 2002, pp. 23 to 25, http://oemagazine.com/from the magazine/mar 02/biref.html), the angular dependence of intrinsic birefringence in the fluoride crystal with cubic crystal structure is explained in detail. According to this article the intrinsic birefringence of a beam is dependent both on the aperture angle and on the azimuth angle of a beam. In the above-mentioned article symmetries are described in detail which are present if the lens axis is disposed in the (100), the (111) or in the (110) direction. Through the concurrent use of a plurality of lenses having different crystallographic orientations of the lens axes and optionally by rotating these lenses with respect to one another, the optical path difference for two orthogonal polarisation states of the transiting light in a projection lens can be reduced.

However, the literature does not focus on a difference between a projection lens working exclusively with refractive optical elements and a catadioptric projection lens, with regard to the compensation of intrinsic stress birefringence.

It is the object of the present invention so to configure a catadioptric projection lens of the type mentioned in the preamble of claim 1 that it is optimised with respect to its intrinsic birefringent properties.

This object is achieved by the invention specified in claim 1.

The basis of the present invention is the recognition that the polarisation-sensitive reflective layer contained in the catadioptric part of the catadioptric projection lens decouples the catadioptric part of the lens from the dioptric part adjacent to the image plane with respect to polarisation. In practice, imperfect compensation of intrinsic birefringence in the catadioptric part of the lens has effects only on the light intensity in the image plane, but not on the relative phase positions of the two mutually orthogonal polarisation components in the image plane.

The objective, in compensating intrinsic birefringence in the catadioptric part of the lens, is not only to minimise the intensity loss but in addition to keep the antisymmetric component of the apodisation associated with the intensity loss as small as possible. The symmetrisation of apodisation minimises the telecentricity error. Furthermore, an, in particular rotation-symmetrical, apodisation can be easily corrected by a suitable neutral density filter.

Unlike the case with the catadioptric part of the projection lens, uncompensated intrinsic birefringence in the dioptric lens part adjacent to the image plane causes a phase difference in the polarisation components of the light in the image plane, and not an intensity loss. The degree of compensation of the intrinsic birefringence in the dioptric part adjacent to the image plane can therefore be best described as the phase difference between the polarisation components. This, too, should ideally be zero.

The decoupling of the catadioptric part of the lens from the dioptric part of the lens adjacent to the image plane with respect to polarisation which has been described has the result that refractive optical elements in the catadioptric part of the lens cannot be used to compensate the intrinsic birefringence in the dioptric part of the lens adjacent to the image plane. Rather, the intrinsic birefringence must be minimised separately in both parts of the lens. Only then are both a minimum intensity loss and a minimum path difference between the two polarisation components in the image plane, and therefore an optimum imaging quality, achieved.

In addition to the dioptric part adjacent to the image plane, most catadioptric projection lenses also have a dioptric part adjacent to the object plane, with which the light issuing from the object is guided into the beam deflection direction. In this case there are, according to the invention, two alternative ways of compensating intrinsic birefringence:

In the first alternative the dioptric part adjacent to the object plane is also compensated separately from the catadioptric part and from the dioptric part adjacent to the image plane with respect to birefringence. However, with regard to optimum configuration of apodisation, it is more advantageous if the dioptric part adjacent to the object plane and the catadioptric part are compensated jointly, but separately from the dioptric part adjacent to the image plane, with respect to intrinsic birefringence.

The reason is to be seen in the fact that, in the dioptric part adjacent to the object plane also, imperfectly compensated intrinsic birefringence does not lead to a phase difference but, as in the catadioptric part of the projection lens, only to a change of intensity and apodisation in the image plane.

In the case of the operating wavelength of 157 nm primarily considered for the projection lens, only refractive optical elements consisting of fluoride, in particular calcium or barium fluoride, are practically possible.

The separate compensation of the intrinsic birefringence in the catadioptric part of the projection lens is made more difficult because only relatively few refractive optical elements, in particular lenses, are located in this part. A sufficiently good compensating effect is achieved in the embodiments of the invention which are the subjects of claims 4 to 10. Here, use is made of the fact that the lenses located in the catadioptric part are transited by light having only a relatively small maximum aperture angle.

The catadioptric part may contain a further lens of birefringent material. In this case the crystallographic orientations specified in claims 11 to 14 have proved favourable.

The dioptric part of the projection lens adjacent to the object plane can in general be compensated with respect to its intrinsic birefringence in that, in the optical elements located therein, the (100) direction is disposed parallel to the optical axis. This manner of compensation is practicable because the maximum aperture angle of the rays, i.e. the maximum angle of the ray in relation to the optical axis of the element, is also very small in this region.

In addition to geometric beam deflecting arrangements in which the reflecting surface is substantially metallic or reflects through dielectric layer structures, in very recent years beam deflecting arrangements have increasingly been used which consist of two prisms of birefringent material, in particular calcium fluoride, between which a polarisation-sensitive beam-splitting layer is arranged as the reflecting layer. As is explained in more detail below, a beam-splitting layer of this kind is distinguished by the fact that one polarisation component of the incident light is substantially reflected whereas the polarisation component perpendicular thereto is substantially transmitted. This beam-splitting layer therefore has a strongly polarising effect, resulting in an especially strong decoupling, with regard to polarisation, between those parts of the projection lens which are located on opposite sides of the beam-splitting layer.

The two prisms of this beam deflecting arrangement also consist of crystalline fluoride material and therefore are also birefringent. This birefringence, too, requires compensation. This is not unproblematic in the prism facing towards the catadioptric part of the projection lens, because said prism has passing through it ray bundles the principal rays of which in general cannot be oriented parallel to a crystal direction in which intrinsic birefringence is low or zero, either before or after reflection. Compromises must therefore be made here:

A first compromise of this kind provides that, in the prism facing towards the catadioptric part, the (100) direction is disposed parallel to the optical axis of the catadioptric part. This takes account of the fact that this prism is transited twice by a light bundle approximately parallel to the optical axis of the catadioptric part, whereas the light bundle coming from the object passes through this prism only once. A further advantage of this arrangement is that both prisms of the beam-deflecting arrangement can be cut from a single block of (100) material without incurring a significant material loss.

The second, less preferred possibility consists in the fact that, in the prism facing towards the catadioptric part, a (100) direction includes with the optical axis of the lens part located upstream of the beam-splitting layer the same angle as that which an (optionally different) (100) direction includes with the optical axis of the catadioptric part.

The compensation of the intrinsic birefringence in the prism which faces towards the dioptric part adjacent to the image plane is usefully effected in that the (100) direction is disposed parallel to the optical axis of the catadioptric part.

It is a further object of the present invention to specify a method for compensating the intrinsic birefringence in a catadioptric projection lens.

This object is achieved by the invention specified in claim 20. The advantages of this method according to the invention, like those of the advantageous embodiments specified in claims 21 and 22, correspond to the above-described advantages of the catadioptric projection lens according to the invention.

An embodiment of the invention is elucidated in detail below with reference to the drawing; the single FIGURE shows a lens section of a catadioptric projection lens used in a microlithographic projection-exposure apparatus.

In the FIGURE the projection lens is designated as a whole by reference numeral 1. It is used to image in an image plane 3 disposed parallel to the object plane 2, on a reduced scale, for example, a scale of 4:1, a pattern of a reticle arranged in an object plane 2. The projection lens 1 has, adjacent to the object plane 2, a dioptric part 4 which contains exclusively refractive optical elements 8, 9, a beam deflecting arrangement 7, a catadioptric part 5 having a concave mirror 6 and a plurality of refractive optical elements 13 to 16, and a dioptric part 18 downstream of the catadioptric lens part 5 and adjacent to the image plane 3, which dioptric part 18 also contains only refractive optical elements 20 to 34.

The first dioptric part 4 of the projection lens 1 contains a lambda/4 plate 8, the significance of which will be discussed below, together with a plano-convex lens 9.

The beam deflecting arrangement 7 takes the form of a beam splitter cube and is composed of two prisms at 7a, 7b which are triangular in cross-section. Located between these prisms is a polarisation-selective beam-splitting layer 10, configured as a so-called “SP layer”. This means, ideally, that the beam-splitting layer 10 reflects 100% of the component (S component) of the electrical field perpendicular to the plane of incidence of the light, whereas it transmits 100% of the component (P component) of the electrical field parallel to the plane of incidence. Real beam-splitting layers 10 of the SP type come extremely close to these ideal values.

The beam-splitting layer 10 is disposed obliquely with respect to the optical axis 11 of the first dioptric lens part 4, such that the angle of deflection is somewhat greater than 90°, for example, 103° to 105°. By means of the lambda/4 plate 8 contained in the first dioptric lens part 4 it is ensured that the light issuing from the object impinges on the beam-splitting layer 10 with the S-polarisation required for reflection.

In the catadioptric part 5 of the projection lens 1 the light reflected at the beam-splitting layer 10 first strikes a relatively thin negative meniscus lens 13 and then immediately strikes a further lambda/4 plate 14. By means of the lambda/4 plate 14 the light coming from the beam-splitting layer 10 is given circular polarisation. In this form it passes through two further negative meniscus lenses 15, 16 and is then reflected by the concave mirror 6.

The light then passes in the opposite direction through the diffractive optical elements 16, 15, 14, 13 of the catadioptric part 5 of the projection lens 1. On its second transit through the lambda/4 plate 14 the circularly polarised light is converted back into light with linear polarisation which, however, now impinges on its second transit with P-polarisation on the beam-splitting layer 10 and is therefore transmitted by the latter.

The light passing through the beam-splitting layer 10 impinges on a flat deflection mirror 17 which is so aligned that the optical axis 19 of the second dioptric part 18 of the projection lens 1 is disposed parallel to the optical axis 11 of the first dioptric part 4. This is equivalent to saying that the image plane 3 extends parallel to the object plane 2. The second dioptric lens part 18 includes a total of fifteen refractive optical elements, thirteen of which, denoted by reference numerals 20 to 32, are lenses, one, denoted by reference numeral 33, being a further lambda/4 plate and the last element before the image plane 3 being a plane-parallel end plate.

Because the projection lens 1 which has been described is intended for use with light in the far-ultraviolet range, in particular with a wavelength of 157 nm, all the refractive optical components consist of calcium fluoride. The intrinsic birefringence of these refractive optical elements, which is associated with this material, requires compensation. Because of the particular configuration of the projection lens 1 as a catadioptric lens with the polarisation-selective beam-splitting face 10, peculiarities which will be discussed in more detail below arise in this context:

The polarisation-selective beam-splitting layer 10 decouples the dioptric lens part 4 adjacent to the object plane 2 from the catadioptric lens part 5, and decouples the latter in turn from the dioptric lens part 18 adjacent to the image plane 3.

The following will be said first in explanation of the dioptric lens part 4: without the appropriate compensation the birefringence of the elements 8, 9 causes a change in the polarisation state of the light before reflection by the beam-splitting layer 10. The light is no longer exclusively S-polarised and therefore is not completely reflected. The light which takes on the incorrect polarisation state through the intrinsic birefringence is absorbed or transmitted in the beam-splitting layer 10. A reduction in the intensity of the light entering the catadioptric part 5 of the projection lens 1 therefore takes place. The intrinsic birefringence in the first dioptric part 4 therefore does not substantially influence the phase position in the image plane 3 but changes only the light intensity in that plane.

The situation is similar inside the catadioptric lens part 5: an intrinsic birefringence in the refractive optical elements 13, 14, 15, 16, which are transited twice after reflection by the beam-splitting layer 10, causes a change in the polarisation state of the light striking the beam-splitting layer 10 for the second time unless particular measures are taken to counter this effect. The light contains an unwanted S-polarisation component which is either reflected or absorbed instead of being transmitted by the beam-splitting layer 10, so that this light, too, is finally lacking at the image plane 3. This effect can lead to a change of more than 10 percent in intensity and also impair the image quality. For example, the lineararity of the structures imaged or the telecentricity are impaired.

Because of their intrinsic birefringence, the refractive optical elements 20 to 34 in the dioptric lens part 18 adjacent to the image plane 3 also cause a change of polarisation state. Here, however, unlike the case with the dioptric lens part 4 adjacent to the object plane 2 and with the catadioptric lens part 5, there is no downstream polarisation-sensitive layer. This has the effect that the change of polarisation state in the image plane 3 results in a phase difference of the polarisation components and not in a change of intensity.

The above-described decoupling of the different parts 4, 5 and 18 of the projection lens 1 with respect to polarisation has the result that the intrinsic birefringence in each of these parts 4, 5, 18 must be compensated individually. It is therefore not possible, in particular, to include refractive elements from the dioptric part 4 adjacent to the object plane 2 and from the catadioptric part 5 in the compensation of the intrinsic birefringence of the dioptric part 18 of the projection lens 1 adjacent to the image plane 3.

In the following description of the manner in which the intrinsic birefringence is compensated in the different parts of the projection lens 1, various terms are used which are defined below.

In defining the rotational position of an optical element use is made of a “reference direction”. This reference direction is disposed perpendicularly to the plane of projection of the FIGURE and is oriented towards the viewer.

The quality of compensation in the dioptric part 4 adjacent to the object plane 2 and in the catadioptric part 5 is characterised by an “intensity loss”. This is the maximum loss in intensity between the object plane 2 and the image plane 3 of a light bundle issuing from the object plane, which is caused by the particular optical elements under consideration.

As a further parameter for the quality of compensation in the dioptric part 4 and in the catadioptric part 5 adjacent to the object plane 2 an “antisymmetric component” of apodisation is used. This parameter is defined as the maximum value of

Iₐₙₜᵢ=[I(xₚ,yₚ)−I(−xₚ,−yₚ)]/2,

where I(xₚ, yₚ) is the intensity at a point in the pupil having the coordinates xₚ, yₚ.

The intrinsic birefringence in the dioptric part 4 adjacent to the object plane 2 is compensated substantially by the following measures:

Because the maximum aperture angle of the ray bundle issuing from the axial point is relatively small in the first dioptric lens part 4 (only 8.3° in the embodiment illustrated concretely), both the lambda/4 plate 8 and the lens 9 can be manufactured from (100) or (111) material disposed in any desired rotational position with respect to one another.

To minimise the intrinsic birefringence in the first prism 7a of the beam deflecting arrangement 7b, there are two preferred possibilities:

Because the angle of deflection between the dioptric part 4 adjacent to the object plane 2 and the catadioptric part 5 of the projection lens 1 deviates from 90°, it is not possible to align a (100) crystal direction both parallel to the optical axis 11 of the dioptric part 4 and parallel to the optical axis 12 of the catadioptric part 5.

In a first possible compromise the crystallographic orientation of the first prism 7a of the beam deflecting arrangement 7 is so selected that a (100) crystal direction includes with the optical axis 11 of the dioptric lens part 4 the same angle as that which a second (100) crystal direction includes with the optical axis 12 of the catadioptric lens part 5. In this case the intensity loss in the image plane for the ray bundle issuing from the axial point is 3%, while the antisymmetric component of apodisation is 0.68%.

Alternatively, it is possible to position the (100) crystal direction parallel to the optical axis 12 of the catadioptric lens part 5. Account is taken here of the fact that the light rays coming from the dioptric part 4 of the projection lens 1 pass through at the first prism 7a only once, whereas the light rays passing through the catadioptric part 5 pass through the first prism 7a of the beam deflecting arrangement 7 twice. In this case the change in intensity in the image plane 3 is 2.15%. The non-rotationally-symmetric component of apodisation is 0.04%. This second solution is also better for material-related reasons: the two prisms 7a and 7b can be cut from a cube without material losses.

Both solutions are equivalent if, unlike the case with the embodiment illustrated, the angle between the optical axis 11 of the dioptric part 4 adjacent to the object plane 2 and the optical axis 12 of the catadioptric part 5 is 90°.

For compensation of the intrinsic birefringence within the catadioptric part 5 of the projection lens 1 there are again various options.

Because the catadioptric part 5 of the projection lens 1 contains only relatively few refractive elements, in particular only three lenses 13, 15, 16, it is not possible, as in the prior art mentioned at the outset, to obtain very good compensation of the intrinsic birefringence by combining a plurality of lenses, with their axes oriented correspondingly, into groups, and by reciprocal rotation within the groups and between the groups. Under these more difficult conditions the solution is sought while taking account of the maximum aperture angle prevailing in the particular refractive elements under consideration.

To compensate the meniscus lenses 15, 16 of the catadioptric part 5 there are various possibilities:

### EXAMPLE 1

The axes of both lenses (15, 16) are disposed in the (110) direction. The rotational angle between the [1-10] crystal direction of the one lens 15 and the reference direction is 0°, while the rotational angle between the [1-10] crystal direction of the other lens 16 and the reference direction is 90°. The intensity loss occurring in this case is 3.15%, while the antisymmetric component of apodisation is 0.62%.

### EXAMPLE 2

The axes of both lenses (15, 16) are disposed in the (110) direction. The rotational angle between the [1-10] crystal direction of the one lens 15 and the reference direction is 90°, while the rotational angle between the [1-10] crystal direction of the other lens 16 and the reference direction is 0°. The intensity loss occurring in this case is 3.02%, while the antisymmetric component of apodisation is 0.54%.

### EXAMPLE 3

The axes of both lenses (15, 16) are disposed in the (111) direction. The rotational angle between the [1-10] crystal direction of the one lens 15 and the reference direction is 0°, while the rotational angle between the [1-10] crystal direction of the other lens 16 and the reference direction is 60°. The intensity loss occurring in this case is 13.63%, while the antisymmetric component of apodisation is 5.95%.

### EXAMPLE 4

The axes of both lenses (15, 16) are disposed in the (111) direction. The rotational angle between the [1-10] crystal direction of the one lens 15 and the reference direction is 30°, while the rotational angle between the [1-10] crystal direction of the other lens 16 and the reference direction is 90°. The intensity loss occurring in this case is 8.02%, while the antisymmetric component of apodisation is 3.21%.

### EXAMPLE 5

The axes of both lenses (15, 16) are disposed in the (100) direction. The rotational angle between the [010] crystal direction of the one lens 15 and the reference direction is 0°, while the rotational angle between the [010] crystal direction of the other lens 16 and the reference direction is 45°. The intensity loss occurring in this case is 11.36%, while the antisymmetric component of apodisation is 4.29%.

### EXAMPLE 6

The axes of both lenses (15, 16) are disposed in the (100) direction. The rotational angle between the [010] crystal direction of the one lens 15 and the reference direction is 45°, while the rotational angle between the [010] crystal direction of the other lens 16 and the reference direction is 90°. The intensity loss occurring in this case is 15.96%, while the antisymmetric component of apodisation is 6.52%.

In the first meniscus lens 13 of the catadioptric part 5 the maximum beam aperture angle is 14°. Again, there are various possibilities of reducing the disturbing effect of the intrinsic birefringence caused by this lens 13 in conjunction with the above examples 1 to 6:

### EXAMPLE 6

The axis of the lens 13 is disposed in the (100) crystal direction. The angle included by the [010] crystal direction with the reference direction is 0°. With the orientation of the meniscus lenses 15, 16 mentioned in the above Example 2, a total intensity loss of 2.43% and a total antisymmetric component of apodisation of 0.60% are obtained. With the orientation of the meniscus lenses 15, 16 mentioned in the above Example 4, a total intensity loss of 6.35% and a total antisymmetric component of apodisation of 2.48% are obtained.

### EXAMPLE 7

The axis of the lens 13 is disposed in the (100) crystal direction. The angle included by the [010] crystal direction with the reference direction is 45°. With the orientation of the meniscus lenses 15, 16 mentioned in the above Example 2, a total intensity loss of 2.30% and a total antisymmetric component of apodisation of 0.60% are obtained. With the orientation of the meniscus lenses 15, 16 mentioned in the above Example 4, a total intensity loss of 5.92% and a total antisymmetric component of apodisation of 2.21% are obtained.

### EXAMPLE 8

The axis of the lens 13 is disposed in the (111) crystal direction. The angle included by the [1-10] crystal direction with the reference direction is 30°. With the orientation of the meniscus lenses 15, 16 mentioned in the above Example 2, a total intensity loss of 3.63% and a total antisymmetric component of apodisation of 1.20% are obtained. With the orientation of the meniscus lenses 15, 16 mentioned in the above Example 4, a total intensity loss of 3.99% and a total antisymmetric component of apodisation of 0.87% are obtained.

### EXAMPLE 9

The axis of the lens 13 is disposed in the (111) crystal direction. The angle included by the [1-10] crystal direction with the reference direction is 90°. With the orientation of the meniscus lenses 15, 16 mentioned in the above Example 2, a total intensity loss of 4.83% and a total antisymmetric component of apodisation of 1.99% are obtained. With the orientation of the meniscus lenses 15, 16 mentioned in the above Example 4, a total intensity loss of 12.65% and a total antisymmetric component of apodisation of 5.04% are obtained.

The compensation of the intrinsic birefringence within the second prism 7b of the beam deflecting arrangement 7 is effected in that the crystallographic (100) direction is positioned parallel to the optical axis 12 of the catadioptric lens part 5.

Finally, the intrinsic birefringence within the dioptric lens part 18 adjacent to the image plane 3 can, because sufficient refractive optical elements are available in that part, be compensated according to a method described in detail in the prior art, for example, by the concurrent use of calcium and barium fluoride or by the concurrent use of counter-rotated lenses of fluoride crystal, the lens axes of which are oriented in the (100) or in the (111) crystal directions. These methods will not be discussed in detail here.

1. A catadioptric projection lens, in particular for use in a microlithographic projection-exposure apparatus, for imaging in an image plane an object arranged in an object plane, comprising
a) a catadioptric part including a plurality of refractive optical elements through which the light rays pass twice and an imaging mirror;
b) a dioptric part adjacent to the image plane which includes a plurality of exclusively refractive optical elements;
c) a beam-deflecting arrangement which guides the light rays issuing from an object point located in the object plane into the catadioptric part and a polarisation-sensitive reflective layer,
characterised in that
d) at least some of the refractive optical elements in the catadioptric part (5) and in the dioptric part (18) adjacent to the image plane (3) consist of a material which has intrinsic birefringence,
e) through selection of the crystallographic orientation of the material and/or of the material and/or of the compensation coatings for at least some of the birefringent refractive optical elements, the disturbing part of the intrinsic birefringence is at least partially reduced,
f) the catadioptric part (5) and the dioptric part (18) being compensated separately from one another with respect to intrinsic birefringence.

2. Catadioptric projection lens according to claim 1, having a dioptric part adjacent to the object plane, characterised in that the dioptric part (4) adjacent to the object plane (2) is compensated separately from the catadioptric part (5) and from the dioptric part (18) adjacent to the image plane (3) with respect to intrinsic birefringence.

3. Catadioptric projection lens according to claim 1, having a dioptric part adjacent to the object plane, characterised in that the dioptric part (4) adjacent to the object plane (2) and the catadioptric part (5) are compensated jointly but separately from the dioptric part (18) adjacent to the image plane (3) with respect to intrinsic birefringence.

4. Catadioptric projection lens according to any one of the preceding claims, characterised in that the birefringent refractive optical elements consist of fluoride, in particular calcium or barium fluoride.

5. Catadioptric projection lens according to claim 4, characterised in that the catadioptric part (5) contains two lenses (15, 16) the axes of which are disposed parallel to the (110) direction, the [1-10] direction of the first lens (15) including an angle of 0°, and the [1-10] direction of the second lens (16) an angle of 90°, with a reference direction which is disposed perpendicularly to the plane of projection of the FIGURE and is oriented towards the viewer.

6. Catadioptric projection lens according to claim 4, characterised in that the catadioptric part (5) contains two lenses (15, 16) the axes of which are disposed parallel to the (110) direction, the [1-10] direction of the first lens (15) including an angle of 90°, and the [1-10] direction of the second lens (16) an angle of 0°, with a reference direction which is disposed perpendicularly to the plane of projection of the FIGURE and is oriented towards the viewer.

7. Catadioptric projection lens according to claim 4, characterised in that the catadioptric part (5) contains two lenses (15, 16) the axes of which are disposed parallel to the (111) direction, the [1-10] direction of the first lens (15) including an angle of 0°, and the [1-10] direction of the second lens (16) an angle of 60°, with a reference direction which is disposed perpendicularly to the plane of projection of the FIGURE and is oriented towards the viewer.

8. Catadioptric projection lens according to claim 4, characterised in that the catadioptric part (5) contains two lenses (15, 16) the axes of which are disposed parallel to the (111) direction, the [1-10] direction of the first lens (15) including an angle of 30°, and the [1-10] direction of the second lens (16) an angle of 90°, with a reference direction which is disposed perpendicularly to the plane of projection of the FIGURE and is oriented towards the viewer.

9. Catadioptric projection lens according to claim 4, characterised in that the catadioptric part (5) contains two lenses (15, 16) the axes of which are disposed parallel to the (100) direction, the [010] direction of the first lens (15) including an angle of 0°, and the [010] direction of the second lens (16) an angle of 45°, with a reference direction which is disposed perpendicularly to the plane of projection of the FIGURE and is oriented towards the viewer.

10. Catadioptric projection lens according to claim 4, characterised in that the catadioptric part (5) contains two lenses (15, 16) the axes of which are disposed parallel to the (100) direction, the [010] direction of the first lens (15) including an angle of 45°, and the [010] direction of the second lens (16) an angle of 90°, with a reference direction which is disposed perpendicularly to the plane of projection of the FIGURE and is oriented towards the viewer.

11. Catadioptric projection lens according to any one of claims are 4 to 10, characterised in that the catadioptric part (5) contains a further lens (13) the axis of which is disposed parallel to the (100) direction, the [010] direction of the further lens (13) including an angle of 0° with a reference direction which is disposed perpendicularly to the plane of projection of the FIGURE and is oriented towards the viewer.

12. Catadioptric projection lens according to any one of claims are 4 to 10, characterised in that the catadioptric part (5) contains a further lens (13) the axis of which is disposed parallel to the (100) direction, the [010] direction of the further lens (13) including an angle of 45° with a reference direction which is disposed perpendicularly to the plane of projection of the FIGURE and is oriented towards the viewer.

13. Catadioptric projection lens according to any one of claims are 4 to 10, characterised in that the catadioptric part (5) contains a further lens (13) the axis of which is disposed parallel to the (111) direction, the [1-10] direction of the further lens (13) including an angle of 30° with a reference direction which is disposed perpendicularly to the plane of projection of the FIGURE and is oriented towards the viewer.

14. Catadioptric projection lens according to any one of claims are 4 to 10, characterised in that the catadioptric part (5) contains a further lens (13) the axis of which is disposed parallel to the (111) direction, the [1-10] direction of the further lens (13) including an angle of 90° with a reference direction which is disposed perpendicularly to the plane of projection of the FIGURE and is oriented towards the viewer.

15. Catadioptric projection lens according to any one of the preceding claims, characterised in that in the refractive optical elements (8, 9) of the dioptric part (4) adjacent to the object plane (2) the (100) direction is disposed parallel to the optical axis (11).

16. Catadioptric projection lens according to any one of the preceding claims, characterised in that the beam-deflecting arrangement (7) consists of two prisms (7a, 7b) of birefringent material, in particular fluoride, between which a polarisation-sensitive beam-splitting layer (10) is arranged as a reflective layer.

17. Catadioptric projection lens according to claim 16, characterised in that in the prism (7a) facing towards the catadioptric part (5) the (100) direction is disposed parallel to the optical axis (12) of the catadioptric part (5).

18. Catadioptric projection lens according to claim 16, characterised in that in the prism (7a) facing towards the catadioptric part (5) a (100) direction includes with the optical axis (11) of the lens part (4) adjacent to the object plane (2) the same angle as that which a (100) direction includes with the optical axis (12) of the catadioptric part (5).

19. Catadioptric projection lens according to any one of claims 16 to 18, characterised in that in the prism (7b) which faces towards the dioptric part (18) adjacent to the image plane (3) the (100) direction is disposed parallel to the optical axis of the catadioptric part (5).

20. A method for compensating the intrinsic birefringence in a projection lens, in particular for a microlithographic projection-exposure apparatus, which comprises
a) a catadioptric part including a plurality of refractive optical elements through which the light source passes twice and an imaging mirror;
b) a dioptric part adjacent to the image plane which includes a plurality of exclusively refractive optical elements;
c) a beam-deflecting arrangement which guides the light rays issuing from an object point located in the object plane into the catadioptric part and a polarisation-sensitive reflective layer,
characterised in that
e) the disturbing influence of the intrinsic birefringence is reduced by selection of the crystallographic orientation of the material and/or of the material and/or of the compensation coatings in at least some of the birefringent refractive optical elements in the dioptric part (18) adjacent to the image plane (3), separately from the catadioptric part (5).

21. Method according to claim 20, in which the projection lens additionally includes a dioptric part adjacent to the object plane, characterised in that the dioptric part (4) adjacent to the object plane (2) is compensated separately from the catadioptric part (5) and from the dioptric part (18) adjacent to the image plane (3) with respect to intrinsic birefringence.

22. Method according to claim 20, in which the projection lens additionally includes a dioptric part adjacent to the object plane, characterised in that the dioptric part (4) adjacent to the object plane (2) and the catadioptric part (5) are compensated jointly but separately from the dioptric part (18) adjacent to the image plane (3) with respect to intrinsic birefringence.
